(19) United States
(12) Patent Application Publication
(10) Pub. No.: US 2010/0151256 A1
(43) Pub. Date: Jun. 17, 2010

(54) Method for Producing a Component from a Fiber Reinforced Ceramic, in particular, for Use as a Power Plant Component

(76) Inventors: Steffen Beyer, Muenchen (DE); Rolf Meistring, Glonn (DE); Franz Maidl, Wallerfing (DE); Stephan Schmidt, Dauchau (DE); Christian Wilhelmi, Friedrichshafen (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/529,508

(22) PCT Filed: Feb. 25, 2008
(86) PCT No.: PCT/DE08/00335

§ 371 Date: Jan. 6, 2010

(30) Foreign Application Priority Data
Mar. 2, 2007 (DE) 10 2007 010 6752

(51) Int. Cl. B32B 18/00; B05D 3/02

(52) U.S. Cl. 428/446; 427/333

(57) ABSTRACT

A method for producing a component having a base body made of a carbon fiber reinforced ceramic and a protective layer which is applied on the base body includes the following steps: providing the base body: applying a first layer on the base body, the first layer comprising a slip with reactive carbon; applying a second layer on the first layer, the second layer comprising a slip with silicon. The application of the layers can be carried out by painting, brushing, filling or dipping techniques, or by fully automatable spraying devices. Finally, the silicon of the second layer is liquefied in a thermal treatment, so that the liquid silicon penetrates into the first layer and forms with the reactive carbon a reaction protective layer composed of a silicon carbide compound.

This application is a national stage of PCT International Application No. PCT/DE2008/000335, filed Feb. 25, 2008, which claims priority under 35 U.S.C. §119 to German Patent Application No. 10 2007 010 675.2, filed Mar. 2, 2007, the entire disclosure of which is herein expressly incorporated by reference.

### BACKGROUND AND SUMMARY OF THE INVENTION

The present invention relates to a method for producing a component which has a base body made of a carbon fiber reinforced ceramic, and a protective layer which is applied on the base body.

Fiber reinforced ceramics are used wherever high temperature and high wear stresses prevail. Typical fields of application include space technology, chemical plant technology and automotive brake disk technology and/or clutch technology. Bundles of carbon fibers which are embedded on the surface of such ceramic components, however, oxidize at a continuous high temperature in the presence of an oxygen atmosphere, leaving voids and forming the basis for abrasive wear.

Therefore, in order to protect fiber reinforced ceramic base bodies, it is known to provide the base body at least partially with a protective layer, which is resistant to wear, corrosion (and/or oxidation) or abrasion. To this end, thin protective layers, made of a ceramic material, for example, silicon carbide (SiC), are often used. The drawbacks with such prior art protective layers lie in the fact that the limited choice of material often results in a poor adaptation of the different thermal expansion coefficients of the base body and the protective layer, which can lead to the formations of fractures in the protective layer. Furthermore, it is frequently the case that impermeable protective layers cannot be achieved, because the ceramic yield during the production process is limited, and, moreover, decomposition reactions take place. Depending on the composition, the protective layer can be effective only for specific temperature ranges and limited periods of application, a feature that must be observed during installation of a component in high temperature environments.

German patent document DE 103 48 123 B3 discloses a method for producing a component, made of carbon fiber reinforced silicon carbide ceramic, and a protective layer, which is applied on the component. According to this method, a pre-body is produced for the protective layer. The material properties of said pre-body can be adjusted in such a manner that they satisfy in an optimal way the properties of the protective layer. The production of the pre-body of the protective layer is carried out so as to be totally uncoupled from the production of the compression molding material of the actual component.

During compression molding, the pre-body of the protective layer is integrated into a CRP (carbon fiber reinforced plastic) body of the component, so that in the next stage it carbonizes together with the CRP body and is infiltrated with the silicon. Embedding the pre-body of the protective layer during the compression molding of the CRP body produces a two-dimensional connection, which is generated by a deliquescence of the dry resin, between the CRP body and the pre-body of the protective layer. The result is the desired bonding between the CRP body and the pre-body of the protective layer. Finally the pre-body of the protective layer and the CRP body cure together.

A drawback with this method is that the production method of the base body has to be modified. Furthermore, the method can be employed only for the processing of compression molding materials.

German patent document DE 197 46 598 A1 discloses a carbon fiber reinforced ceramic composite material, on which is applied a protective layer that comprises three layers. A bottom oxidation protective layer assumes the function of a primer and surface sealant with thermal expansion coefficients, adjusted to the base material, from one or more of the materials SiC, SiO₂, or B. A center oxidation protective layer assumes the function of an oxygen getter through the formation of oxide and/or through sealing local cracks by forming glass from one or more compounds containing Si or B. A top oxidation protective layer has the function of erosion protection and adaptation of the emission and absorption of radiation and is made, for example, of SiC. The protective layers can be applied by way of slips made of inorganic fillers, organic binders and solvents. One drawback with this technique is the technical complexity of laying up the plurality of layer sequences.

Finally, German patent document DE 101 33 635 A1 discloses a ceramic composite body, which exhibits a supporting zone and a cover layer, which is made of composite ceramic, and which is provided for the abradant wear and is exposed to the access of air. Between the supporting zone and the cover layer there is a protective layer, the composition of which is similar to that of the composite material of the supporting zone and which contains additives for the formation of self-healing layers. It provides oxidation protection of oxidation sensitive fibers that are contained in the supporting zone.

One object of the present invention is to protect a base body, which is made of a carbon fiber reinforced ceramic and includes oxidation sensitive fractions, against oxidative damage, in particular due to the access of air. In this case the resulting component is suitable for high-temperature use.

This and other objects and advantages are achieved by the method according to the invention for producing a component which has a base body made of a carbon fiber reinforced ceramic and a protective layer, which is applied on the base body. The inventive method comprises the following steps: providing the base body; applying a first layer on the base body, the first layer comprising a slip with reactive carbon; applying a second layer on the first layer, the second layer comprising a slip with silicon; and carrying out a thermal treatment, in which the silicon of the second layer is liquefied so that the liquid silicon penetrates into the first layer and forms with the reactive carbon a reaction protective layer composed of a silicon carbide compound. The slip can be applied either by simple techniques, such as painting, brushing, filling and dipping techniques, or by fully automatable spraying devices.

The inventive method also allows the formation of a protective layer, which is referred to as the reaction protective layer, on a fiber reinforced ceramic base body, the thermal expansion of which is adapted to the material of the base body. In addition, the base body is suitable for high-temperature use.

The material of the base body is chosen in such a way that the softening temperature is above the melting temperature of silicon. In particular, the melting temperature has to be above 1,420° C., since in the step in which the thermal treatment is carried out, temperatures of at least 1,420° C. are reached for melting the silicon. In particular, silicon carbide (SiC) or carbon (C) is selected as the ceramic material for the base body. Then the carbon fiber reinforced base body is made of C/C or C/SiC. In particular, a component, which is produced according to the method of the invention, can be used as a power plant component.

Due to the separate application of “reactive carbon” in the first layer and “silicon” in the second layer, an adaptation to the thermal expansion coefficients of the material of the base body can be achieved in a simple manner. With this strategy it is possible to avoid or minimize the risk of forming fractures due to the varying thermal expansion.

The method according to the invention provides advantages relating to production engineering, because it is possible to generate the reaction protective layer on a base body, made of fiber reinforced ceramic material at a low cost, even in the case of complex structures. In particular, it is possible to produce the base body in its final shape using known production methods. Not until the subsequent next step is the reaction protective layer produced on the base body in the described way. This reaction protective layer protects the oxidation sensitive carbon fibers, contained in the base body, against corrosion and/or oxidation and, optionally, also erosion.

Moreover, according to an advantageous embodiment of the inventive method, the intrinsic strength and fracture toughness of the reaction protective layer can be enhanced by admixing reinforcement fibers (in particular, short fibers composed of a carbon containing material) to the slip of the first layer.

Furthermore, in order to improve the mechanical properties of the reaction protective layer, powdery inert or reactive materials, which influence the mechanical properties of the reinforcement fibers in the first layer, are added to the slip of the first layer as the additives to the reactive carbon. In order to influence the thermal expansion of the first layer, powdery inert or reactive materials can be added to the slip of the first layer as the additives to the reactive carbon.

The formation of the reaction protective layer by applying two layers on the base body of the component to be produced offers the advantage that the volume percentages of the reactive carbon and silicon can be determined in a simple manner in the slip. In particular, it can be provided that the degree of conversion and/or the composition of the reactive layer can be controlled by means of the volume percentage of the reactive carbon in the first layer and/or the volume percentage of the silicon in the second layer.

Furthermore, it is provided that silicon in the slip of the second layer is provided in such a quantity that during the formation of the reaction protective layer there is an excess of silicon, and that a siliconizing, at least on the surface, of the carbon fiber reinforced ceramic of the base body is produced. In this way, good bonding of the reaction protective layer to the base body can be achieved.

In another embodiment silicon in the slip of the second layer is provided in such a quantity that during the formation of the reaction protective layer there is an excess of silicon, in order to seal by vapor phase siliconizing an inner surface of the base body in the case of a sandwich structure of the base body.

The inventive method according to the invention for producing a protective layer on a ceramic base body enables a graduated siliconizing; that is, control of the composition inside the reaction protective layer. For example, a silicon enrichment on the surface of the reaction protective layer can be provided. Higher carbon percentages can be designed as a transition layer to the base body. In particular, a reactive bonding of the reaction protective layer through additional siliconizing of the carbon regions that are near the surface of the base body is possible.

The application of the slip for the first layer comprising reactive carbon on the base body and/or the application of the slip for the second layer comprising silicon on the first layer is carried out either by simple techniques like painting, brushing, filling techniques or dipping, or by means of conventional, fully automatable spraying devices. At the same time the slip properties, such as solids content and the viscosity, are adapted to the employed techniques by means of suitable measures. The advantage associated with the use of spraying devices lies in the ability to fully automate the coating process of base bodies with simple geometries and/or more complex components, like power plant components. In addition, the invention comprises a component with a base body, made of a carbon fiber reinforced ceramic, for example, C/C or C/SiC, and a protective layer that is applied on the base body. The protective layer is produced according to the process described herein. In particular, the component is provided as a power plant component.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a cross section of a base body, on which are applied a first layer and a second layer in successive process steps;

FIG. 2 is a schematic illustration of a cross section of the component to be produced, after thermal treatment; and

FIG. 3 is a flow chart of the inventive method according to the invention for producing a component with a protective layer that is suitable for high temperatures.

### DETAILED DESCRIPTION OF THE DRAWINGS

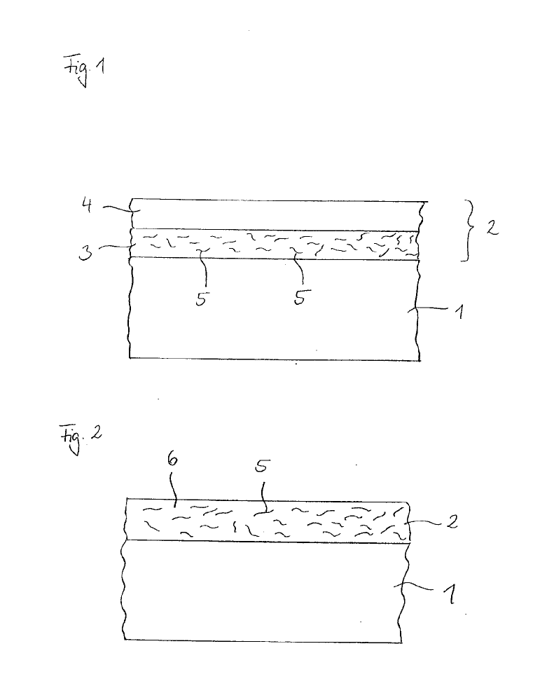

FIG. 1 is a schematic cross sectional view of a component which has a base body 1, made of a carbon fiber reinforced ceramic (for example, C/C or C/SiC) and a layer sequence 2, which is applied on the base body 1, in order to form a protective layer. FIG. 1 shows the component in a production state in which the base body 1 (for example, a power plant component) is already finished. Then a first layer 3 is applied on a surface of the base body 1 to protect against corrosion or oxidation and optionally erosion. In this case the first layer 3 comprises a slip with reactive carbon and preferably reinforcement fibers 5, in particular, short fibers composed of carbon.

In another step of the process a second layer 4, comprising slip with silicon, is applied on the first layer 3. In addition, the first layer 3 can comprise further additives (in particular, inert or reactive powdery additives), which influence the thermal expansion of the finished reaction protective layer on the surface of the base body 1. The addition of reinforcement fibers 5 in the slip of the first layer 3 influences the mechanical properties of a finished reaction protective layer.

The layup shown in FIG. 1 is subjected to a thermal treatment in which temperatures above the melting temperature of silicon (that is, above 1,420° C.) are reached. During the thermal treatment the liquefied silicon of the second layer 4 penetrates into the first layer 3, where it reacts with the carbon to form silicon carbide SiC. This process is depicted schematically in the cross-sectional view in FIG. 2. The resulting reaction protective layer 6 protects the base body 1 against corrosion and/or oxidation during high temperature use. At the same time the thermal expansion coefficient of the generated reaction protective layer 6 is or can be adapted to the thermal expansion coefficient of the base body 1 on the basis of the composition of the materials of the first layer 3. Thus, the risk of forming cracks due to the varying thermal expansions is avoided or at least minimized. The addition of reinforcement fibers 5 enhances the intrinsic strength and fracture toughness of the reaction protective layer 6 and, thus, results in a better protection of the base body 1.

Depending on the composition of the first layer 3 and the percentage of silicon in the second layer 4, the degree of conversion and/or the composition of the reaction protective layer 6 can be controlled. Hence, it is possible, for example, in the event of excess silicon in the second layer to siliconize the surface of the base body 1, so that it is possible to achieve a good bonding of the reaction protective layer 6 to the base body 1. If the base body 1 is configured as a sandwich structure, then the inner surfaces can be sealed by vapor phase siliconizing.

The inventive method for producing the reaction protective layer, that is, application of a first layer and a second layer on a carbon fiber reinforced ceramic base body by painting, brushing, filling, dipping or by fully automatable spraying devices, can be carried out not only on flat surfaces, but also on base bodies having surfaces of a complex design. At the same time the method can be carried out cost-effectively, because it is not necessary to make any modifications whatsoever to the production process of the base body 1 itself, and because the reaction protective layer can be produced after the production of the base body 1.

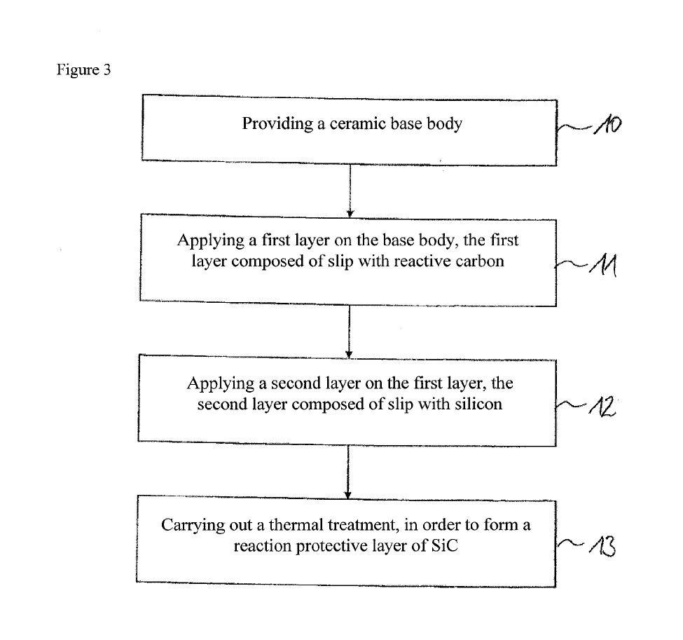

FIG. 3 shows once again the sequence of the process according to the invention. In a first process step 10 a carbon fiber reinforced ceramic base body is provided. Then in a second process step 11 a first layer of slip with reactive carbon is applied on this base body. In an additional process step 12 a second layer of slip with silicon is applied on the first layer. Finally a thermal treatment is carried out, in order to form a reaction protective layer composed of silicon carbide (process step 13), by liquefying the silicon of the second step.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 base body made of a carbon fiber reinforced ceramic

2 layer sequence

3 first layer composed of slip with reactive carbon

4 second layer composed of slip with silicon

5 reinforcement fibers

6 reaction protective layer

10 process step

11 process step

12 process step

13 process step

1-12. (canceled)

13. A method for producing a component having a base body made of a carbon fiber reinforced ceramic, and a protective layer, which is applied on the base body, said method comprising:
providing the base body;
applying a first layer on the base body, the first layer comprising a slip with reactive carbon;
applying a second layer on the first layer, the second layer comprising a slip with silicon; and
carrying out a thermal treatment, in which the silicon of the second layer is liquefied so that the liquid silicon penetrates into the first layer and forms with the reactive carbon a reaction protective layer composed of a silicon carbide compound.

14. The method as claimed in claim 13, wherein short reinforcement fibers comprising a carbon containing material, are admixed to the slip of the first layer.

15. The method as claimed in claim 14, wherein powdery inert or reactive materials, which influence the mechanical properties of the reinforcement fibers in the first layer, are added to the slip of the first layer as the additives to the reactive carbon.

16. The method as claimed in claim 14 wherein powdery inert or reactive materials, which influence the thermal expansion of the first layer, are added to the slip of the first layer as the additives to the reactive carbon.

17. The method as claimed in claim 13, wherein a degree of conversion or the composition of the reaction protective layer can be controlled by adjusting at least one of a volume percentage of the reactive carbon in the first layer and a volume percentage of the silicon in the second layer.

18. The method as claimed in claim 13, wherein:
silicon in the slip of the second layer is provided in such a quantity that during the formation of the reaction protective layer there is an excess of silicon; and
the carbon fiber reinforced ceramic of the base body is siliconized, at least on its surface.

19. The method as claimed in claim 13, wherein silicon in the slip of the second layer is provided in such a quantity that during the formation of the reaction protective layer there is an excess of silicon, in order to seal, by vapor phase siliconizing, an inner surface in the case of a sandwich structure of the base body.

20. The method as claimed in claim 13, wherein one of application of the slip for the first layer on the base body and application of the slip for the second layer on the first layer is carried out by at least one of painting, brushing, filling, dipping, and using fully automatable spraying devices.

21. The method as claimed in claim 13, wherein in the step the thermal treatment is carried out at temperatures that reach at least 1,420° C.

22. The method as claimed in claim 13, wherein one of silicon carbide (SiC) and carbon (C) is selected as a ceramic material for the base body.

23. A component comprising a base body, made of a carbon fiber reinforced ceramic, and a protective layer, applied on said base body, wherein the protective layer is made by the process according to claim 13.
